(19) United States
(12) Patent Application Publication
(10) Pub. No.: US 2024/0316893 A1
(43) Pub. Date: Sep. 26, 2024

(54) Corrugated Pizza Box and Method for Production of Same

(71) Applicant: Semi Corr Containers, Inc., Phillips, WI (US)

(72) Inventor: James Alan Cummings, Phillips, WI (US)

(21) Appl. No.: 18/410,548

(22) Filed: Jan. 11, 2024

Related U.S. Application Data
(63) Continuation-in-part of application No. 18/243,403, filed on Sep. 7, 2023, now Pat. No. 11,938,705.
Application No. 18/243,403 is a continuation-in-part of application No. 18/123,675, filed on Mar. 20, 2023, now Pat. No. 11,794,439.

(51) Int. Cl. B31F 1/24

(52) U.S. Cl. CPC B31F 1/24

(57) ABSTRACT

A corrugated pizza box is made using a web fed rotary die cutter with the web produced by a corrugator singlefacer that is speed synchronized with the rotary die cutter. The singlefacer produces SemiCorr Singleface Board (SSB) made possible by special corrugating rolls that allow a bottom liner to be bonded to a fluted and creased medium or liner within the singlefacer. This medium or liner has cross flute bond lines that provide in-line stiffness to the two-ply board exiting the singlefacer.

### CROSS-REFERENCE TO RELATED APPLICATIONS

This application is a continuation-in-part of U.S. patent application Ser. No. 18/243,403, filed Sep. 7, 2023, which is a continuation-in-part of U.S. patent application Ser. No. 18/123,675, filed Mar. 20, 2023, now issued as U.S. Pat. No. 11,794,439, each of which is incorporated by reference herein in their entireties.

### FIELD OF THE INVENTION

The present invention pertains to a corrugated pizza box product and a method for its manufacture. More specifically, the corrugated pizza box product is made using a two-ply panel that will significantly reduce the fiber content of the pizza box.

### BACKGROUND OF THE INVENTION

Corrugated pizza boxes are a large component of total corrugated products produced in the United States. There are over 3 billion pizzas sold on average each year. These pizzas are mostly packaged in B flute singlewall corrugated board made from a top and bottom liner and a fluted medium.

Pizza boxes are typically made from sheets that are run on a corrugator. The sheets are then conveyed in stacks to a rotary die cutter line where they are fed by automatic sheet feeding equipment into the rotary die cutter hopper. The hopper then feeds individual sheets into the rotary die cutter where they are printed, die cut, and stacked as finished pizza box blanks.

Damage to sheets and waste can occur during the sheet handling process. Potential for jam-up exists in the die cutter hopper especially with warped board. The corrugator, conveyors, sheet feeder, die cutter, and die cut stacker are much more expensive than the pizza box line envisioned by the present invention. Further, there is a significant problem associated with the use of conventional singlewall corrugated boxes related to the condensation of steam in the box that can make the pizza soggy and unappealing. With the huge production of pizza boxes, a reduction in the cost of the box can net significant savings.

Consequently, there is a need for pizza box design that is simultaneously less expensive with a better performance and a method for production of the box that is more efficient and requires less capital investment.

### SUMMARY OF THE INVENTION

Making pizza boxes using a two-ply panel versus the three-ply B flute singlewall board results in fiber reduction of over 30% providing huge savings for corrugated producers. The savings of 30% of the fiber in a pizza box is significant. Eliminating a 26 #/MSF liner from a pizza box would save over $10/MSF at current prices. (MSF=1,000 square feet)

U.S. Pat. No. 11,794,439 B1, “Semi-Corrugated Paperboard Panels and Method for Production of Same,” issued Oct. 24, 2023, also to the present inventor, discloses manufacture of a two-ply paperboard product, called “SemiCorr,” which can be used in the production of pizza boxes.

SemiCorr is comprised of a fluted and creased medium that forms a creased base layer than can be run out of a singlefacer and up onto the bridge of a corrugator without bonding to a top liner. The creased base layer has cross flute bond lines formed by crease tools embedded in the SemiCorr corrugating rolls. These cross flute bond lines are normally facing in a downward direction so that they can be bonded to a bottom liner in the doublebacker of the corrugator. However, a version of SemiCorr uses an inverted creased base layer with cross flute bond lines facing in an upward direction. In this case, the creased base layer can be bonded directly to a bottom liner that is run in place of a top liner in the singlefacer to create a product called SemiCorr Singleface Board (SSB). SSB is structurally stiff in the in-line direction as well as cross machine direction right out of the singlefacer.

However, this version of SemiCorr could not be run up onto the bridge of the corrugator to be accumulated and conveyed to downstream equipment as the product would not be amenable to forming a bridge buffer.

The corrugated pizza box of the present invention is made using a web fed rotary die cutter with the web produced by a corrugator singlefacer that is speed synchronized with the rotary die cutter. The singlefacer produces SSB made possible by special corrugating rolls that allow a bottom liner to be bonded to a fluted and creased medium or liner within the singlefacer. This medium or liner has cross flute bond lines that provide in-line stiffness to the two-ply board exiting the singlefacer.

The two-ply pizza box manufactured using the web fed rotary die cutter replaces the three-ply pizza box thereby reducing the cost of the box. The manufacturing process itself is very efficient and significantly reduces the capital investment required to manufacture a pizza box.

In one embodiment of the present invention, the SSB from the singlefacer enters a hot plate system that further cures the board. The hot plate system has a pull section that securely holds the web. The web exits the hot plate system and is run directly into a rotary die cutter where it is formed into useful two-ply pizza boxes. The continuous SSB of width equal to two or more pizza box panels is run into print cylinders and rotary dies that have circumferences that are an integral multiple of the pizza box in-line direction length to create a continuous die cut web. The panels can be die cut apart in-line to create side-by-side two or three outs of pizza boxes.

In one embodiment of the present invention the continuous printed and die cut web exits the die cutter and enters a slitting station wherein the continuous web is slit into multiple outs of pizza boxes.

In yet another embodiment of the present invention a cutoff knife is used to create individual pizza box panels. The cutoff knife is registered to the pizza box using a cut-to-mark system. As pizza boxes are rather short in length in the machine direction, the cutoff knife cylinder design has a circumference equal to twice the length of the pizza box and uses dual knife blades mounted at 180 degrees spacing so that two pizza boxes can be cut with each revolution of the knife as it runs at a synchronous speed relative to the two-ply web speed. A version of the cutoff knife that uses a profiling controller can adapt the knife cut lengths over the perceived variation in pizza box lengths. The cut-to-length pizza box panels enter a knife outfeed section where they are accelerated to create a gap between boxes that allow them to be shingled and run into a downstacker to form finished loads of die cut pizza boxes.

In yet another embodiment of the present invention, the die cutter simply die-cuts across the web to create the individual pizza box panels without the requirement for a cutoff knife.

In one particularly advantageous embodiment of the invention, the equipment described herein can be designed in a narrow profile to run trim rolls. Trim rolls are the butt ends of rolls slit on a paper machine that are narrow to the point that they are not appropriate to run on a conventional corrugator because of the reduced productivity. These trim rolls are commonly sold at discounts of up to 50% so that the paper mill can sell them on the open market. Making pizza boxes from two-ply SemiCorr board using trim rolls will significantly reduce the cost of the box.

A pizza box made from conventional three ply singlewall board using 26 #/MSF liners and a 20 #/MSF medium will have a combined board basis weight of 78 #/MSF and a cost of $32/MSF at current prices of paper. A two-ply SemiCorr pizza box made from trim rolls with two 26 #/MSF liners will have a combined board basis weight of 52 #/MSF and a cost of $11/MSF at current prices. The difference in cost will result in a savings of nearly 10 cents per pizza box. A narrow pizza box line of the current invention running three-up at a modest production speed of 500 FPM can make 20,000 pizza boxes per hour or 40,000,000 per year. The fiber savings with SemiCorr pizza boxes made using trim rolls on the pizza box line of the current invention compared to conventional pizza boxes would be $4 million per year.

The simple SSB pizza box line with splicers, roll stands, singlefacer, short hot plate section, two print station rotary die cutter, knife and downstacker would have a cost of perhaps $3 million with result being less than a one-year payback.

Further, this technology would mitigate the steam issue associated with the pizza box.

### BRIEF DESCRIPTION OF THE DRAWINGS

The foregoing and other aspects of the present invention will become apparent to those skilled in the art to which the present invention relates upon reading the following description with reference to the drawings below:

FIG. 1 is a perspective view of the inside of the two-ply SemiCorr Singleface Board;

FIG. 2 is a section view of the SemiCorr Singleface Board;

FIG. 3 is an oblique view of the inside of the SemiCorr two-ply pizza box; and

FIG. 4 is a side view layout drawing of the pizza box line.

### DETAILED DESCRIPTION OF THE DRAWINGS

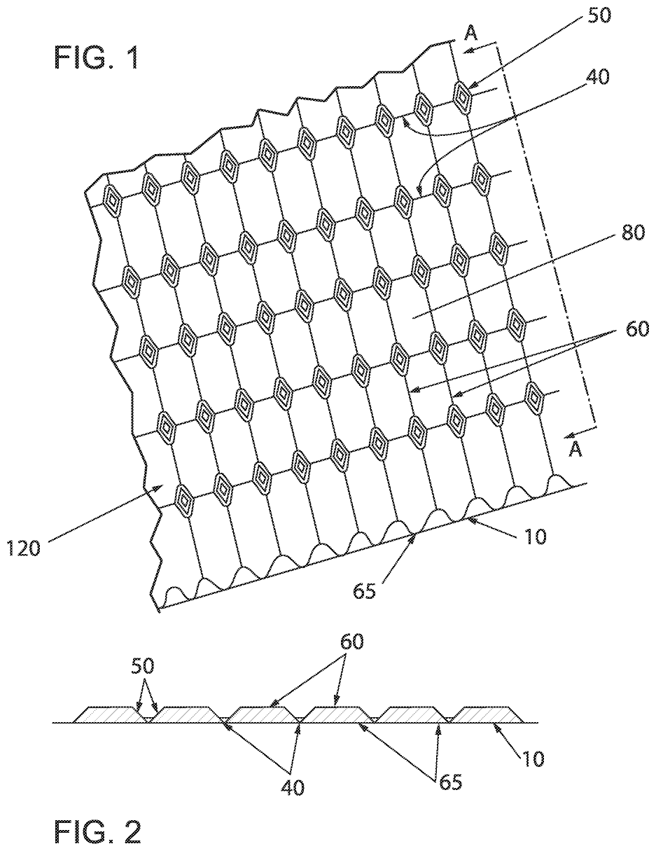

FIG. 1 is the perspective view of the inside of a SemiCorr singleface board 120. The SemiCorr singleface board 120 is comprised of bottom liner 10 adhered to a creased base layer 80. The creased base layer 80 is defined by a conventional fluted medium ply or flutes 60 that has cross flute bond lines 40. The cross flute bond lines 40 are spaced at regular close intervals across the flutes 60 and are bonded along with the bottom tips of the flutes 65 to the inside of bottom liner 10 to form the SemiCorr singleface board 120. The cross flute bond lines 40 are crushed into the flutes 60 by a creasing process that is defined in U.S. Pat. No. 11,794,439 B1, “Semi-Corrugated Paperboard Panels and Method for Production of Same,” hereby incorporated by reference.

The creases 50 are clearly shown in FIG. 2 which is section view A-A of the SemiCorr singleface board of FIG. 1. The cross flute bond lines 40 and the tips of the flutes 65 are bonded to the bottom liner 10 as starch adhesive applied in the glue machine of the singlefacer forms a green bond at the pressure roll.

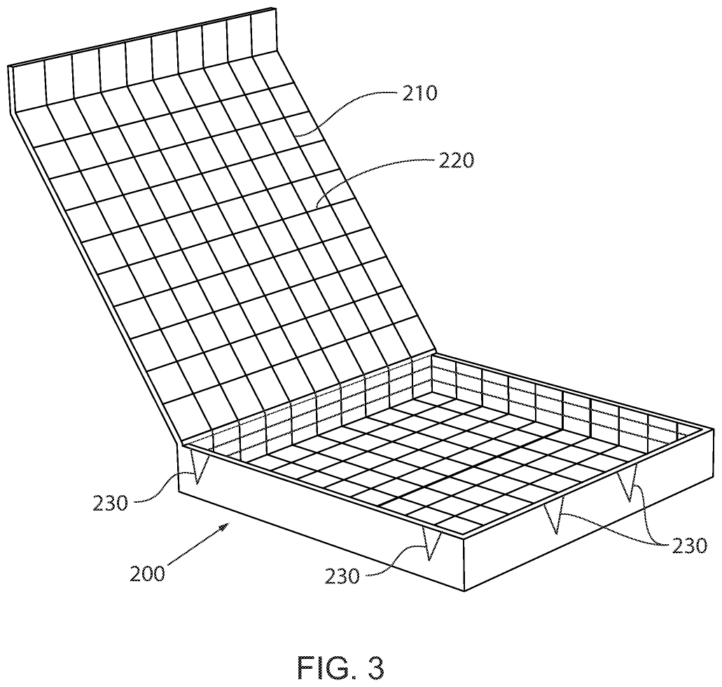

FIG. 3 shows SemiCorr pizza box 200 with creases 210 and flutes 220 exposed on the inside of the box. The flutes and creases lead steam condensing inside the box toward vents 230.

The biggest challenge of pizza box designers is to create a package that retains heat without trapping steam from the hot pizza. The pizza box made from the SSB will have the liner on the outside of the box, but the inside of the box will be comprised of the creased side of the creased base layer which will have the exposed flutes in one direction of the box as well as the crease channels in the other direction of the box. The pressure of steam emanating from the hot pizza will force the steam to flow along the exposed flutes and crease channels towards the edge of the box where vents are positioned as opposed to condensing on the roof of the box and dripping onto the pizza making it soggy.

Careful selection of the medium used for the pizza box will avoid excessive absorption of moisture by the paper itself. A liner or a coated medium can be used to avoid the absorption problem. Following the precepts of the present invention, the pizza box made using the SSB web fed rotary die cutter concept will reduce fiber content of the box thereby significantly lowering its cost while simultaneously improving the box performance.

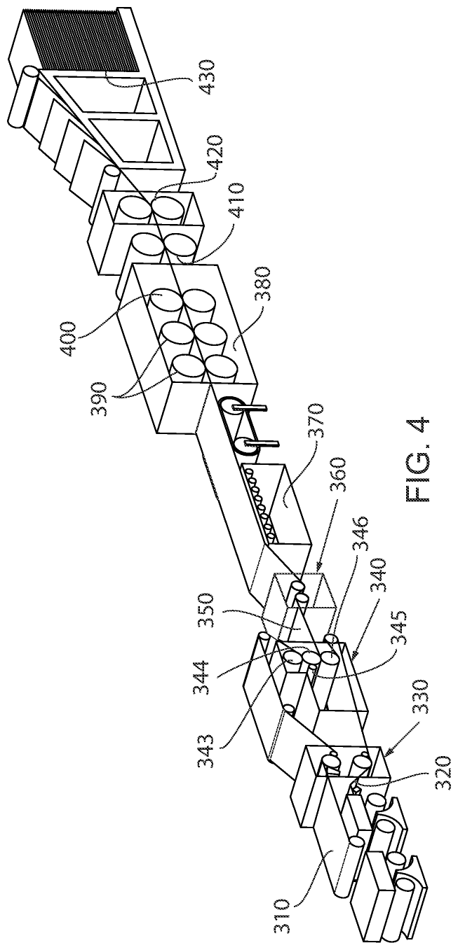

FIG. 4 shows liner 310 and medium (or liner) 320 exiting their respective splicers, entering preheater 330 and then singlefacer 340. The medium is conditioned and then run between upper corrugated roll 343 and lower corrugated roll 344. The fluted and creased medium exits the labyrinth between the corrugating rolls and has starch applied to the flute tips and cross flute bond lines at glue roll 345. The liner is then bonded to the flute tips and cross flute bond lines of the medium with pressure roll 346. The two-ply web 350 then exits the singlefacer 340 and enters a speed synchronization system 360 from which it enters the hot plate system 370 and then rotary die cutter 380.

The rotary die cutter and singlefacer must be speed synchronized. One of these machines is the “master” from a speed point of view. According to the precepts of the present invention, the means of synching the speeds of these machines involves using a table with rollers that can raise or lower taking up the web or feeding it from one machine to the other as speed mismatches develop. A laser sensor measuring the height of the roller table is used to provide feedback to the rotary die cutter or singlefacer drive systems to adjust speeds to keep the machines synchronized.

The web 350 is then printed synchronously by print cylinders 390 and die cut with synchronous die cylinders 400. The web then enters a slit station 410 wherein individual outs are created. The slit webs then enter cutoff knife 420 where they are cut into individual pizza boxes and stacked in downstacker 430.

There are different sizes of pizza box which make it necessary to change the print cylinders to have circumference equal to a multiple integral of the in-line pizza box length to achieve continuous print. It will be necessary to change the rotary die cut cylinder as well with pizza box length change. This may be facilitated with the use of die cut attachments that facilitate a quick change. If the pizza boxes being produced are two-color print or less, it would be possible to incorporate two sets of print cylinders within the die cutter, although this would increase its cost. The pizza box business is huge with very long runs the norm. Consequently, changing die cut cylinders or die cut attachments at order change may not be a big issue.

Another way of getting around changing print cylinders is to use preprint for the bottom liner and register die cut to print. Yet another way of getting around the change of print cylinders is to use digital printing. The dual blade knife cylinder can incorporate profiling controls that allow it to adapt to cutting various pizza box lengths. The slitting blades system can incorporate position preset controls to adapt to change in pizza box width.

For companies with multiple plants within a given geographic area, it may be possible to have the plants consolidate their orders so that a given line could be dedicated to the production of a single size pizza box.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

I claim:

1. A pizza box fabricated from a two-ply panel with the two-ply panel made from a corrugated product comprised of:
a bottom liner; and
a creased base layer of medium or liner that has multiple cross flute bond lines creased at intervals across a fluted web with the multiple cross flute bond lines facing in a downward direction;
wherein the bottom liner is bonded directly to the fluted web and the multiple cross flute bond lines of the creased base layer of medium or liner.

2. A method for making the pizza box of claim 1 comprising
using a production line, wherein a two-ply web exits a singlefacer and enters a rotary die cutter that has a die cut cylinder of circumference equal to a multiple integral of the pizza box in-line length with the rotary die cutter creating pizza box blanks as an output as the two-ply web proceeds through the production line.

3. The method of claim 2 further comprising
using one to four print stations located within the rotary die cutter with cylinders of the print stations of circumference equal to a multiple integral of the pizza box in-line length that print on the pizza boxes.

4. The method of claim 2 further comprising
using a hot plate curing station comprised of a hot plate system, a hold down, and a pulling section located between the singlefacer and the die cutter to cure the two-ply web as it exits the singlefacer.

5. The method of claim 2 further comprising
using a station to take-up the two-ply panel caused by a speed mismatch between the singlefacer and the rotary die cutter that incorporates a control system designed to create synchronized speeds between the singlefacer and the rotary die cutter.

6. The method of claim 2 further comprising
slitting individual outs as the two-ply web exits the rotary die cutter.

7. The method of claim 2 further comprising
cutting the pizza box blanks to length with a cutoff knife after leaving the rotary die cutter.

8. The method of claim 7 wherein the cutoff knife is comprised of a knife cylinder with dual mounted blades located such that each rotation of the knife cylinder cuts two pizza boxes.

9. The method of claim 8 wherein the cutoff knife includes profile controls that allow the knife to cut variable length pizza boxes.

10. The method of claim 7 further comprising
providing a knife outfeed section that pulls gaps between pizza boxes cut by the cutoff knife.

11. The method of claim 2 further comprising
providing a downstacker that forms multiple loads of cut pizza boxes.
